(19) United States
(12) Patent Application Publication
(10) Pub. No.: US 2018/0111280 A1
(43) Pub. Date: Apr. 26, 2018

(54) Shaver With Roller

(71) Applicant: Brett Marut, Miami Beach, FL (US)

(72) Inventor: Brett Marut, Miami Beach, FL (US)

(21) Appl. No.: 15/335,217

(22) Filed: Oct. 26, 2016

(51) Int. Cl. B26B 21/40; B26B 21/52; B26B 21/22

(52) U.S. Cl. CPC B26B 21/4012; B26B 21/22; B26B 21/523

(57) ABSTRACT

A shaver has a handle and a shaver head extending from an end of the handle. The shaver head includes a head housing having a base and a shelf that define a space therebetween, a roller wheel positioned partially inside the space and having a corrugated arrangement of parallel ridges that define channels between adjacent ridges, a plurality of blades secured to the shelf, with the blades partially covering the roller wheel so as to expose a portion of the roller wheel adjacent the plurality of blades, and a blade cover secured over the plurality of blades.

### BACKGROUND OF THE INVENTION

### 1. Field of the Invention

The present invention relates to personal grooming products, and in particular, to a shaver that has a roller for untangling and guiding hair to the blade to be cut.

### 2. Description of the Prior Art

Manual shavers are an essential commodity item as they are used by men and women for shaving facial and body hair. One of the most important requirements for any type of shaver is to effectively cut hair and to deliver a clean shave or cut.

### SUMMARY OF THE DISCLOSURE

It is an object of the present invention to provide a shaver that effectively cuts or shaves body hair.

In order to accomplish the objects of the present invention, the present invention provides a shaver having a handle and a shaver head extending from an end of the handle. The shaver head includes a head housing having a base and a shelf that define a space therebetween, a roller wheel positioned partially inside the space and having a corrugated arrangement of parallel ridges that define channels between adjacent ridges, a plurality of blades secured to the shelf, with the blades partially covering the roller wheel so as to expose a portion of the roller wheel adjacent the plurality of blades, and a blade cover secured over the plurality of blades.

### BRIEF DESCRIPTION OF THE DRAWINGS

FIG. 1 is a perspective view of a shaver according to one embodiment of the present invention.

FIG. 2 is an exploded perspective view of the shaver of FIG. 1.

FIG. 3 is a front view of the shaver of FIG. 1 shown without the blade cover.

FIG. 4 is cross-sectional side view of the shaver of FIG. 1.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices and mechanisms are omitted so as to not obscure the description of the present invention with unnecessary detail.

The present invention provides a shaver 10 that has a shaver head 12 and a handle 14. The handle 14 can be provided in a single piece, or have multiple pieces or sections. For example, the handle 14 can be a telescoping handle that allows the user to adjust the length of the handle 14, or a foldable handle that has two or more pieces or sections that can be folded or nested against each other to reduce the length of the handle 14 for storage. In this regard, this shaver 10 can be used as a shaver for removing facial hair or hair along the legs or other body parts, or it can have a longer handle 14 that allows it to be used as a backshaver. The handle 14 can be made of plastic or any other conventional material used for shaver handles.

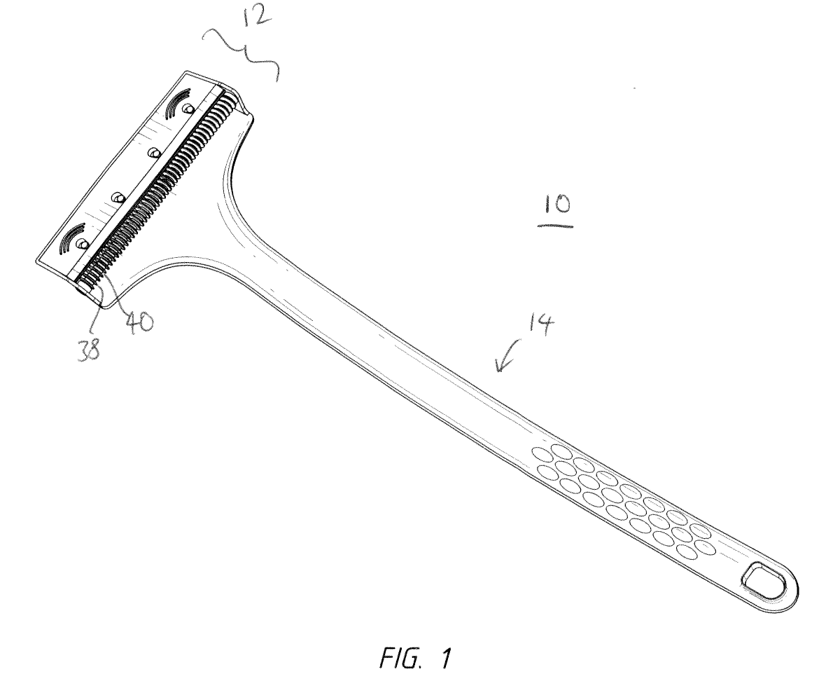

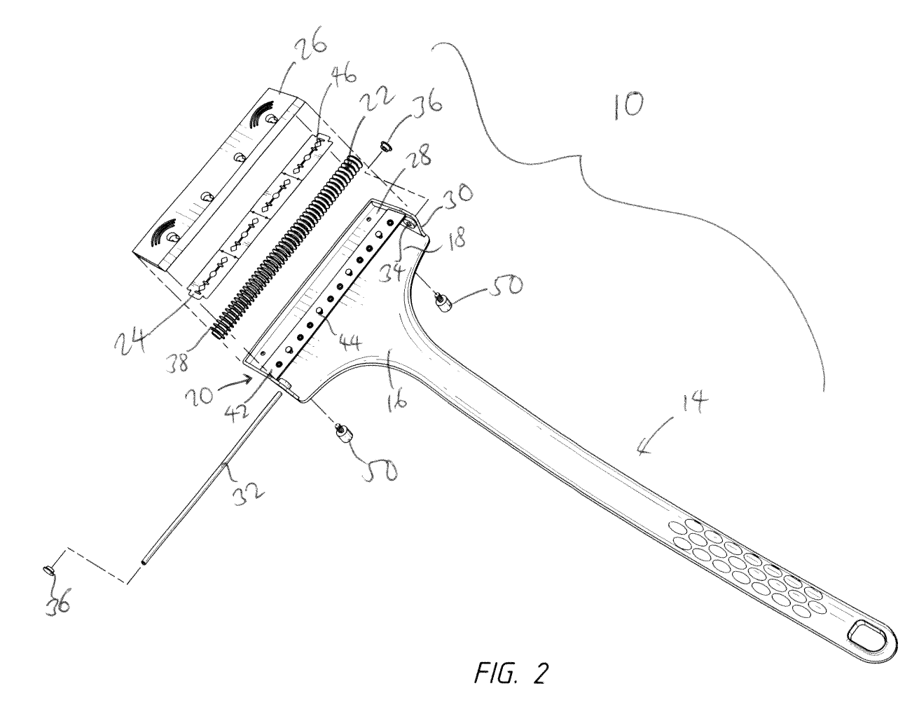

Referring to FIGS. 1-4, the handle 14 has a neck portion 16 that transitions into a base 18 of the shaver head 12. The shaver head 12 has a head housing 20, a roller wheel 22, a plurality of blades 24 and a blade cover 26. The head housing 20 is defined by the base 18, a shelf 28 and two side walls 30. The roller wheel 22 is positioned in a space that is defined between the base 18 and the shelf 28. A shaft 32 extends through a hollow bore 35 that runs along the length of the roller wheel 22, and opposite ends of the shaft 32 extend through holes 34 provided in the side walls 30 and are secured by end caps 36.

The roller wheel 22 has a corrugated arrangement of parallel ridges 38 that define channels 40 between adjacent ridges 38.

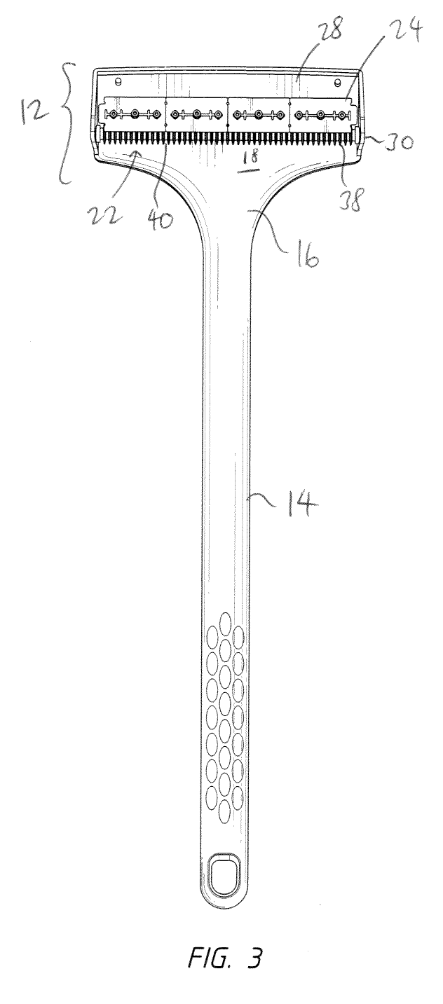

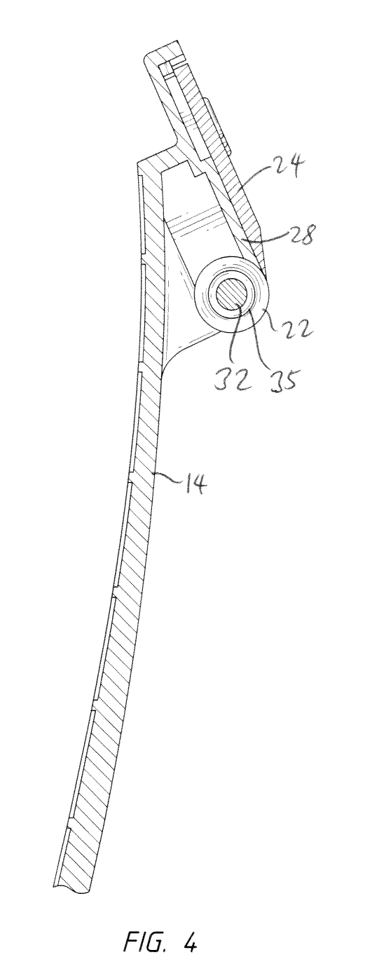

An elongated plate 42 is provided on the front edge of the shelf 28. A plurality of spaced-apart pin-heads 44 are provided along the plate 42. The blades 24 are positioned on the plate 42, with openings 46 in the blades 24 aligned to receive separate pin-heads 44 so that the blades 24 can be removably secured to the plate 42. FIG. 3 shows the roller wheel 22 and the blades 24 secured to the shaver head 12, and from FIG. 3, it can be seen that the blades 24 partially cover the roller wheel 22. FIG. 4 is a cross-sectional view illustrating the relationship of these components, and the close proximity between the blade 24 and the roller wheel 22.

The blade cover 26 is secured over the top of the blades 24 by a pair of screws 50 that extend through the base 18, the shelf 28 and secure to the blade cover 26.

In use, the roller wheel 22 facilitates a better shave by separating the hairs to be cut. Specifically, the corrugated ridges 38 function to untangle hair and to straighten out the hair. The hair is then separated and guided into separate channels 40 before reaching the blade 24, as best shown in FIG. 4. The blade 24 can then deliver a simple clean cut.

The blade 24 and roller wheel 22 can be removed, with the blade 24 replaced if necessary and the roller wheel 22 replaced or cleaned.

The above detailed description is for the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices, components, mechanisms and methods are omitted so as to not obscure the description of the present invention with unnecessary detail.

What is claimed is:

1. A shaver, comprising a handle and a shaver head extending from an end of the handle, the shaver head including:
a head housing having a base and a shelf that define a space therebetween;
a roller wheel positioned partially inside the space and having a corrugated arrangement of parallel ridges that define channels between adjacent ridges;
a plurality of blades secured to the shelf, with the blades partially covering the roller wheel so as to expose a portion of the roller wheel adjacent the plurality of blades; and
a blade cover secured over the plurality of blades.

2. The shaver of claim 1, wherein the head housing further includes two side walls that connect the base and the shelf, further including a shaft that extends through a length of the roller wheel, with opposite ends of the shaft extending through holes provided in the side walls.

3. The shaver of claim 1, further including end caps for securing the ends of the shaft to the side walls.

4. The shaver of claim 1, further including a plate that is secured to the shelf, and on which the plurality of blades is secured, the plate having a plurality of spaced-apart pin-heads.

5. The shaver of claim 4, wherein plurality of blades has openings that are aligned to receive separate pin-heads 44 so that the blades can be removably secured to the plate.
